(19) United States
(12) Patent Application Publication
(10) Pub. No.: US 2007/0122772 A1
(43) Pub. Date: May 31, 2007

(54) Art process using focusing squares for all art mediums

(76) Inventor: Irene F. Neff, Hazlet, NJ (US)

Correspondence Address: Irene F. Neff, 48 Virginia Avenue, Hazlet, NJ, 07730, US

(21) Appl. No.: 11/592,541

(22) Filed: Nov. 3, 2006

Related U.S. Application Data
(60) Provisional application No. 60/739,243, filed on Nov. 25, 2005.

(51) Int. Cl. G09B 11/00

(52) U.S. Cl. 434/82

(57) ABSTRACT

Picture Windows is an art process with the assistance of focusing squares. The windows are 3 inches by 3 inch squares of card stock with a one ½ inch square opening in the middle. These windows are used for creating art work through a specific focus from an inspiration picture to the paper canvass or clay. This is done in a jig saw puzzle idea. The original sketch can be original or transferred by graphite paper. This allows a lay person to create in an unlimited way. An experienced artist will benefit from the focused ability to correct errors and accomplish more complex subjects. The limitation of traditional teaching of art is that it is too difficult for most and takes too long to achieve a pleasing result in a subject of preference.

### CROSS REFERENCE TO RELATED APPLICATIONS

This patent application is a continuation of provisional patent application No. 60/739,243 filed Nov. 25, 2005, confirmation NO. 9631 and is hereby incorporated by reference.

### BACKGROUND

The field of endeavor of this invention is the method or process of creating art pictures or sculpture with the assistance of two windows.

When students are taught art in traditional ways they are asked to become proficient at simple then more complex subjects. This is a long process and leaves many people giving up because it is too difficult and time consuming.

An example would be that the limitation of skill to do a portrait for a lay person is from frustrating to impossible.

The artist of more accomplishment encounters difficulty in perception that can be identified and corrected with this process using “Picture Windows”.

### SUMMARY OF THE INVENTION

The advantage of “Picture Windows” is the eye brain focus assistance that by passes the intellectual judgement which is unskilled or flawed.

The isolation of the area of the window presents only shape and color without judgement of the total form. This is done in a jig saw puzzle fashion.

The novice by working from the inspiration picture to the paper with the values and patterns already transferred will have a pleasing result in any subject or difficulty level without long questionable art study.

The object is to allow all who wish to apply medium to paper, canvas or to create sculpture, to accomplish a pleasing result regardless of their skill.

### DETAILED DESCRIPTION OF THE DRAWINGS

The present invention is illustrated by way of example and not limitation in the figures of the accompanying drawings, in which like references indicate similar elements, and in which:

page 1, Front Page View, illustrates “Picture Windows ;”

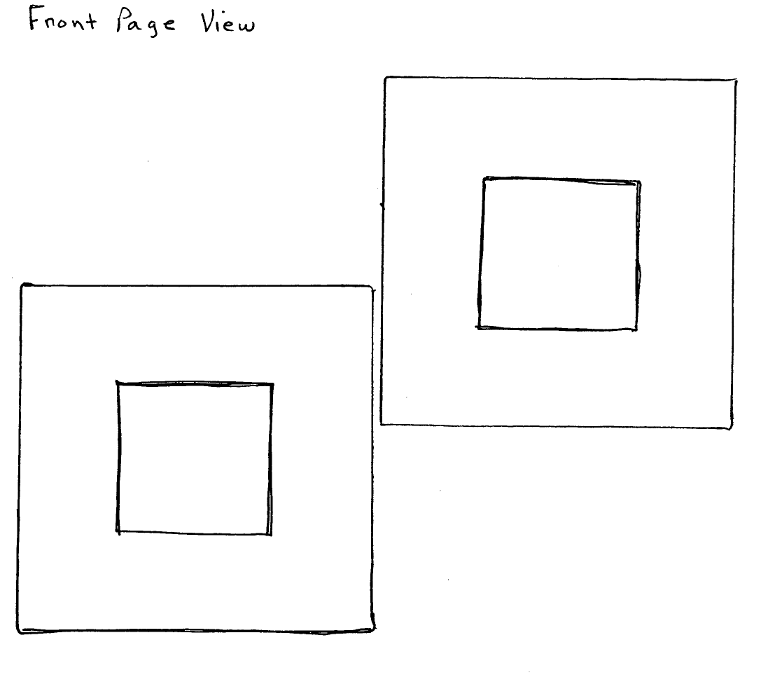

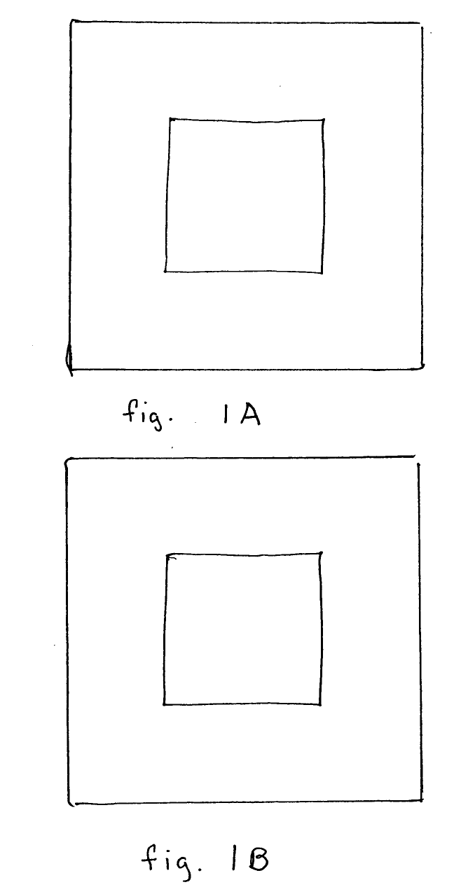

page 2, FIG. 1A, illustrates one picture for placement on original color copy;

page 2, FIG. 1B, illustrates second picture window for placement over transferred or drawn, patterns and values on paper or canvass;

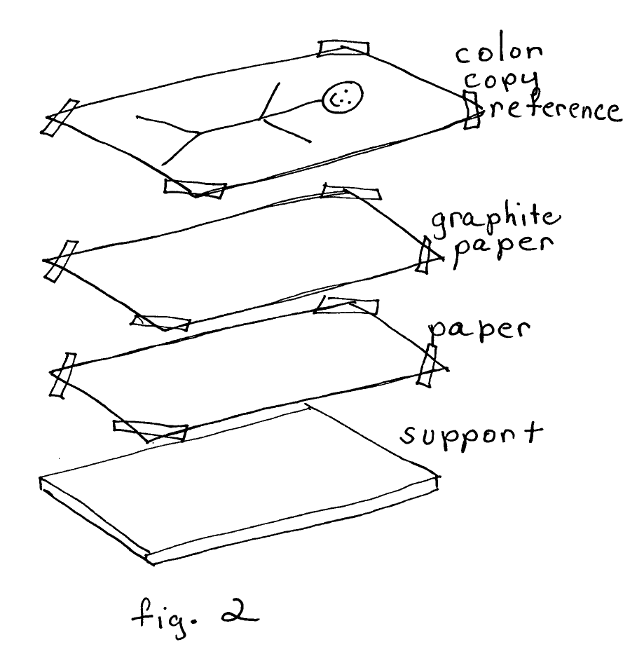

page 3, FIG. 2, illustrates the layering starting from the bottom up, support of canvass or foam core, to paper, to graphite paper, to color copy reference;

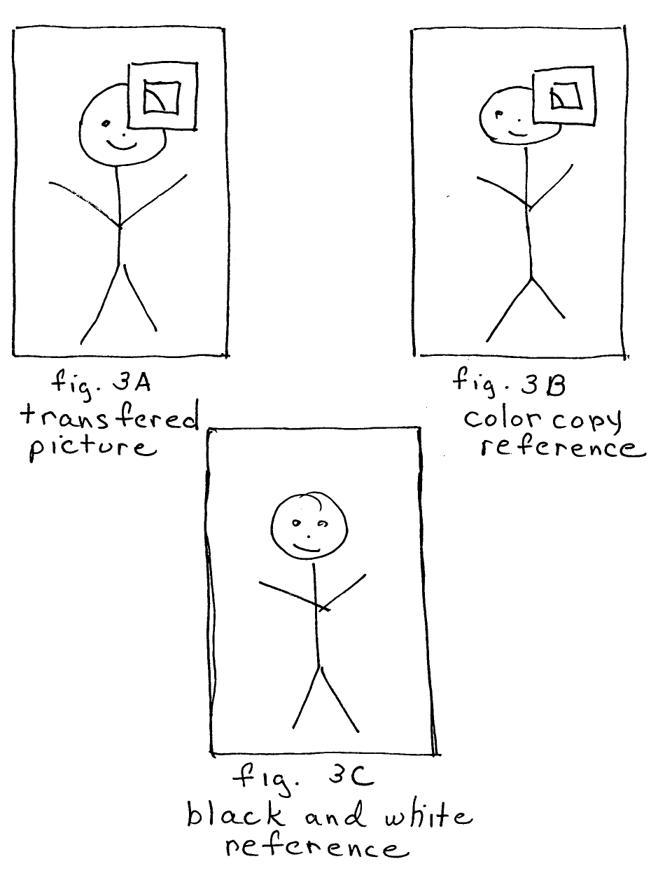

page 4, FIG. 3A illustrates transferred or drawn picture on paper;

page 4, FIG. 3B illustrates color copy reference;

page 4, FIG. 3C illustrates black and white reference;

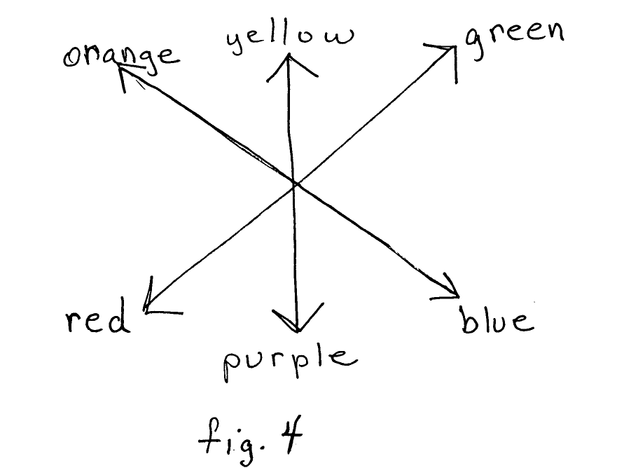

page 5, FIG. 4, illustrates color wheel assist;

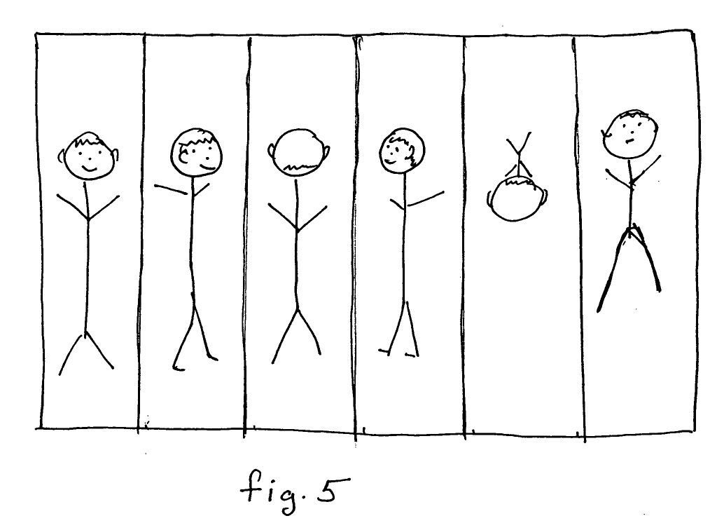

page 6, FIG. 5, illustrates pictures of subject front, back, sides, bottom up, top down;

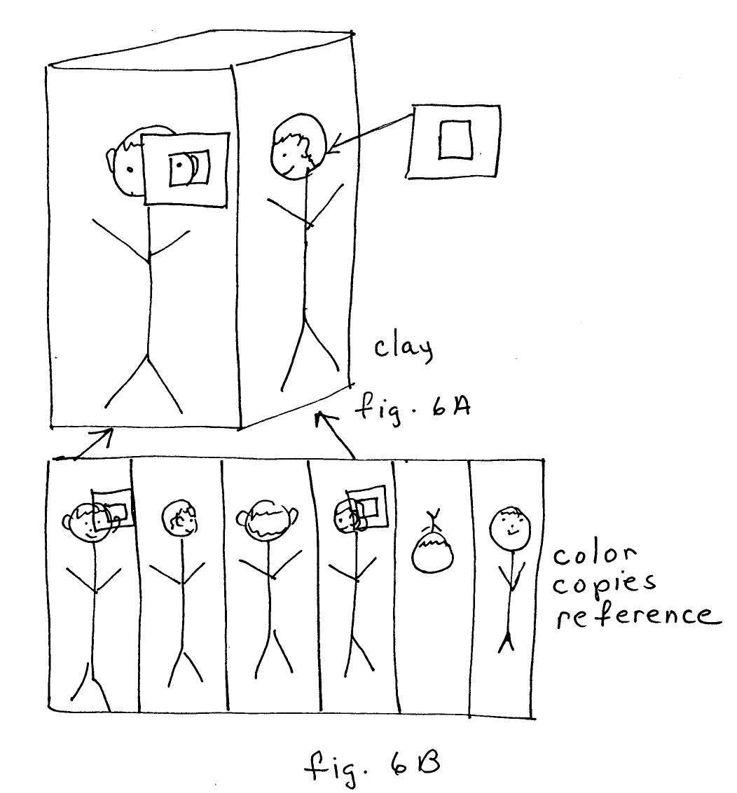

page 7, FIG. 6A, illustrates three dimensional material of choice with picture window;

page 7, FIG. 6B, illustrates six views of subject and picture window isolation of shape and size.

### DETAILED DESCRIPTION

“Picture Windows” is a method of creating a picture or sculpture with the assistance of focusing squares or windows.

The artist choose a subject of meaning to them as difficulty, size or subject, does not matter, their choices unlimited.

The subject for general inspiration purposes would be age appropriate and diverse.

The size paper is personal and important, some like to work very large and some small.

For this example we will transfer the patterns and values onto pastel paper with graphite paper. Other mediums would utilize their respective materials.

Example: pastel paper, to size preferred, is taped to a smooth surface, new canvass or foam board FIG. 2.

The graphite paper is taped to the pastel paper FIG. 2.

The color reference, of size preferred, is taped on top of the graphite paper FIG. 2.

A pencil is used to transfer all patterns and change in values.

When having verified transfer complete, remove all except pastel paper on support.

Using “Picture Windows”, FIG. 1A and FIG. 1B, place one over any area of color reference to begin. Best to work from top to bottom. Place one window over the same area of the transferred picture.

Apply pastel in the shape, color and value seen in the window, move to the next area. As you move continue to reference the black and white copy FIG. 3C, as to the value of the color, how light or dark.

This process is relatable to anyone from age five on. The “Picture Windows” experience opens many possibilities and there are no limitations. We are all artists and the expression need not be limited to only the few.

This may be transmitted by book, with illustrations and instructions or video tape and disk with all the information needed to accomplish pleasing results and release their artist within.

Although the present invention has been described with reference to specific embodiments it will be evident that various modifications and changes may be made to those embodiments without departing from the broader spirit and scope of the invention as set forth in the claims Accordingly the specification and drawings are to be regarded in an illustrative rather than restrictive sense.

For dimensional art you take six pictures of the subject front, back, sides top and bottom up FIG. 5. Photo copies are made to the size the piece will be made.

The picture windows are the same 3 inches by 3 inch card stock with 1½ inch square openings FIG. 1A and FIG. 1B.

Begin with the appropriate size material clay, wood or stone and correspondent tools and materials for that medium FIG. 6A.

Use picture window on view of front of reference picture FIG. 6B, then picture window on material base. Imitate the size and shape of the area chosen FIG. 6A. Move to all areas on that side when complete move to any uncompleted side FIG. 6B and FIG. 6A.

1. I claim to have created a process of creating art flat and three dimensional with a focusing method using Picture Windows.

2. The process of claim 1 is to use 3 inches by 3 inch card stock with 1½ inch square opening in the middle to focus one on inspiration subject and one on the transferred or drawn art piece.
